(19) United States
(12) Patent Application Publication
(10) Pub. No.: US 2007/0163692 A1
(43) Pub. Date: Jul. 19, 2007

(54) Pneumatic tire

(75) Inventors: Atsushi Miyasaka, Tokyo (JP); Yasuo Himuro, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation

(21) Appl. No.: 10/584,287

(22) PCT Filed: Dec. 24, 2004
(86) PCT No.: PCT/JP04/19364

§ 371 Date: Aug. 8, 2006

(30) Foreign Application Priority Data
Dec. 26, 2003 (JP) 2003-432585

(51) Int. Cl. B60C 11/00

(52) U.S. Cl. 152/209.18

(57) ABSTRACT

A pneumatic tire is provided, which readily achieves rain groove wandering resistance without sacrificing wet performance and other performances. Plural steep-angle grooves 16 are provided at opposite sides of the tire equatorial plane CL. Each steep-angle groove 16 is inclined at an angle of not more than 45 degrees relative to the tire circumferential direction, such that the steep-angle groove 16 contacts the ground from a tire equatorial plane CL side. Recessed portions 36 are formed along a tread surface side edge of a land portion adjacent to an inner side in a tire axial direction of the steep-angle transverse groove 16. A depth of the recessed portion 36 gradually increases and a width thereof gradually decreases along a middle portion in a longitudinal directional toward end portion at the tire equatorial plane CL of the steep-angle transverse groove 16. This pattern smoothly drains water around the center of the ground contacting area from the tire equatorial plane CL side to the steep-angle transverse grooves 16 through the recessed portion 36. Although the number of circumferential grooves 14 is small, high wet performance can be obtained. Further, since the number of the circumferential groove 14 is small, rain groove wandering can be suppressed.

### TECHNICAL FIELD

The present invention relates to a pneumatic tire, and particularly to a pneumatic tire which has improved rain groove wandering resistance without sacrificing wet performance and steering stability.

### BACKGROUND

A pneumatic tire having a pattern as shown in FIG. 4 has been proposed for the purpose of improving uneven wear resistance without sacrificing wet performance (see, Patent Document 1).

Further, patterns having steep-angle grooves at the center of the tread where a so-called toe-side land ends are acute angle ends surrounded by grooves and are chamfered are disclosed, for example in Patent Documents 2 to 5, patterns where a land portion(s) continuous in the circumferential direction and ends of steep-angle grooves are positioned within the land portion disclosed, for example, in Patent Documents 6 to 7, and patterns where right and left steep-angle grooves are symmetrical and connected with each other at the center are disclosed, for example, in Patent Documents 8 and 9. Those patters have been well known.
Patent Document 1: Japanese Patent Application Laid-Open (JP-A) No. 5-319025
Patent Document 2: JP-A No. 9-2025
Patent Document 3: JP-A No. 10-58923
Patent Document 4: JP-A No. 8-91025
Patent Document 5: JP-A No. 8-85309
Patent Document 6: JP-A No. 5-286312
Patent Document 7: JP-A No. 10-287108
Patent Document 8: JP-A No. 4-78604
Patent Document 9: JP-A No. 4-43105

### DISCLOSURE OF INVENTION

Problems to be Solved by the Invention

Some highways, for example, in North America employ so-called rain groove roads where many grooves are formed in the road surface in order to improve water drainage.

Water drainage of a tire is improved by forming in the tread a groove extending in the circumferential direction of the tire, however, if a tire pattern includes plural grooves extending in the circumferential direction, the tire pattern may cause so-called rain groove wandering, where steering controllability is lowered on a rain groove road, depending on a combination of grooves' widths and an interval between grooves.

However, merely reducing the number of circumferential directional grooves for suppressing rain groove wandering will lead to another problem of lowering in wet performance of the tire.

The present invention is made to solve the above described problems, and is directed to provide a pneumatic tire with which rain groove wandering resistance is readily achieved without sacrificing wet performance and other performances.

Means for Solving the Problems

The invention recited in claim 1 is a pneumatic tire comprising: steep-angle grooves each provided at opposite sides of a tire equatorial plane of a tread, each steep-angle groove being inclined at an angle of not more than 45 degrees relative to a tire circumferential direction such that the steep-angle grooves contact the ground from a tire equatorial plane side, and an end portion of each steep-angle grooves at the tire equatorial plane side terminating within a land portion; and recessed portions formed along a tread surface side edge of a land portion adjacent to an inner side in a tire axial direction of the steep-angle groove, the depth of the recessed portions increasing and the width of the recessed portion decreasing from a middle portion in a longitudinal direction toward an end portion at the tire equatorial plane side of the steep-angle grooves.

Next, functions of the pneumatic tire recited in claim 1 is described.

In the pneumatic tire recited in claim 1, the plural steep-angle grooves are provided at the opposite sides of the tire equatorial plane of the tread. Each steep-angle groove is inclined at an angle of not more than 45 degrees relative to the tire circumferential direction such that the steep-angle groove contacts the ground from the side thereof at the tire equatorial plane. This tread pattern is a so-called directional pattern, and therefore, water in a ground contacting area can be smoothly drained.

Further, the recessed portions formed along a tread surface side edge of a land portion adjacent to an inner side in a tire axial direction of the steep-angle groove has a depth increasing and a width decreasing from a middle portion in a longitudinal direction toward an end portion at the tire equatorial plane side of the steep-angle grooves. Therefore, water around the center of the ground contacting area can be smoothly drained from the kicking-in side to the steep-angle grooves through the recessed portions.

Accordingly, even if no circumferential groove is provided, or only a small number of circumferential grooves are provided, high wet performance can be obtained.

In addition, since the number of the circumferential groove can be reduced or the circumferential groove can be eliminated, rain groove wandering can be suppressed.

It should be noted that, since the depth of the recessed portion gradually increases and the width thereof gradually decreases from a middle portion in a longitudinal direction toward an end portion at the tire equatorial plane side of the steep-angle grooves, rigidity of the land portion in the vicinity of the recessed portion is ensured.

The invention recited in claim 2 is the pneumatic tire of claim 1, wherein an angle of a boundary line at the tire equatorial plane side between the recessed portions and a tread surface of the land portion relative to the tire circumferential direction is set to not more than 15 degrees in a plan view of the tread, and an angle of land portion side wall surface of the recessed portions relative to a line normal to a tread surface of the tread is set to not more than 30 degrees in a cross sectional view along a tire radial direction and intersecting the longitudinal direction of the steep-angle grooves.

Next, functions of the pneumatic tire recited in claim 2 is described.

By setting the angle of the boundary line relative to the tire circumferential direction to not more than 15 degrees and the angle of land portion side wall surface of the recessed portions to not more than 30 degrees, the recessed portion can efficiently drain water from the tread surface into the steep-angle grooves.

The invention recited in claim 3 is the pneumatic tire of claim 1 or 2, wherein a boundary line at the tire equatorial plane side between the recessed portions and a tread surface of the land portion is arranged such that a boundary line of the recessed portions at one side of the tire equatorial plane and a boundary line at another side of the tire equatorial plane are respectively aligned in a straight line in the circumferential direction, or are spaced apart from each other at an outer side in the tire axial direction.

Next, functions of the pneumatic tire recited in claim 3 is described.

If the boundary lines of the recessed portions at each side of the tire equatorial plane are not spaced apart outward in the tire axial direction, the recessed portions at one side and the other side are alternately aligned on the same circumferential line. This lowers rigidity of the land portion in the vicinity of the tire equatorial plane leading to lower steering stability.

Accordingly, it is preferred that the boundary lines between the recessed portions and the tread surfaces of the land portions at the tire equatorial plane are arranged such that the boundary lines at one side and the other side of the tire equatorial plane are aligned in a straight line in the circumferential direction, or they are spaced apart from each other outer side in the tire axial direction.

The invention recited in claim 4 is the pneumatic tire of any one of claims 1 to 3, wherein recessed portions are formed to extend from a middle portion in a longitudinal direction toward an end portion at the tire equatorial plane side of the steep-angle grooves, and the length of the recessed portion measured along the tire circumferential direction is set within a range of from 25 to 50% of an arrangement pitch of the steep-angle grooves in the tire circumferential direction.

Next, functions of the pneumatic tire recited in claim 4 is described.

In order to efficiently drain water in the vicinity of the tire equatorial plane in the ground contacting area, it is preferred that the recessed portions are formed to extend from the longitudinal directional middle portion of the steep-angle groove to the end portion of the steep-angle groove at the tire equatorial plane side.

If the length of the recessed portion measured along the tire circumferential direction is less than 25% of the arrangement pitch of the steep-angle grooves in the tire circumferential direction, the length of the recessed portion is too short to efficiently drain water into the steep-angle groove.

On the other hand, if the length of the recessed portion measured along the tire circumferential direction exceeds 50% of the arrangement pitch of the steep-angle grooves in the tire circumferential direction, areas are produced where the recessed portions provided at one side and the other side of the tire equatorial plane are positioned side by side in the axial direction. That is, areas which do not contact to the ground are formed at both of right and left portions of the tire equatorial plane resulting in insufficient ground contacting area.

Accordingly, it is preferred that the recessed portions are formed to extend from a middle portion in a longitudinal direction toward an end portion at the tire equatorial plane side of the steep-angle grooves, and the length of the recessed portions measured along the tire circumferential direction is set within a range of from 25 to 50% of the arrangement pitch of the steep-angle grooves in the tire circumferential direction.

The invention recited in claim 5 is the pneumatic tire of any one of claims 1 to 4, wherein a height of a deepest portion of each recessed portions measured from a groove bottom of an adjacent steep-angle groove toward an outer side in a tire radial direction is set within a range of from 25 to 75% of the groove depth of the steep-angle grooves.

Next, functions of the pneumatic tire recited in claim 5 is described.

If the height of the deepest portion of the recessed portion that is measured from the groove bottom of the adjacent steep-angle groove toward an outer side in a tire radial direction is less than 25% of the groove depth of the steep-angle groove, rigidity of the land portions around the recessed portions excessively and unfavorably decreases.

On the other hand, if the height of the deepest portion of the recessed portion measured from the groove bottom of the adjacent steep-angle groove toward an outer side in a tire radial direction exceeds 75% of the groove depth of the steep-angle groove, efficient drainage of water into the steep-angle grooves is hindered.

Accordingly, it is preferred that the height of the deepest portion of the recessed portion measured from the groove bottom of the adjacent steep-angle groove toward an outer side in a tire radial direction is set within a range of from 25 to 75% of the groove depth of the steep-angle grooves.

The invention recited in claim 6 is the pneumatic tire recited in any one of claims 1 to 5, wherein the steep-angle grooves are arranged with a mutual phase difference in the circumferential direction provided at respective sides of the tire equatorial plane.

Next, functions of the pneumatic tire recited in claim 6 is described.

By arranging the steep-angle grooves with a mutual phase difference at respective sides of the tire equatorial plane in the circumferential directions pattern noise can be suppressed, and uniform rigidity of land portion along the circumference and water drainage ability can be obtained.

The invention recited in claim 7 is the pneumatic tire of any one of claims 1 to 6, wherein the angle of the steep-angle grooves relative to the tire circumferential direction is set within a range of from 5 to 30 degrees.

Next, functions of the pneumatic tire recited in claim 7 is described

By setting the angle of the steep-angle grooves relative to the tire circumferential direction within the range of from 5 to 30 degrees, high water drainage ability of the tire on a wet road can be obtained.

The invention recited in claim 8 is the pneumatic tire of any one of claims 1 to 7, further comprising transverse grooves provided at outer sides in the axial direction from the steep-angle grooves. The transverse grooves open at respective tread ground contacting area ends.

Next, functions of the pneumatic tire recited in claim 8 is described.

By providing the transverse grooves, which open at respective tread ground contacting area ends, at outer sides in the tire axial direction from the steep-angle grooves, water led into the steep-angle grooves can be efficiently drained through the transverse grooves to the outer sides in the tire axial direction of the ground contacting areas. It should be noted that the steep-angle grooves may be directly connected to the transverse grooves, or may be connected via other grooves such as circumferential grooves.

The invention recited in claim 9 is the pneumatic tire of any one of claims 1 to 8, further comprising circumferential grooves extending in the tire circumferential direction. The circumferential grooves are disposed in areas, within 40 to 60% from the tire equatorial plane side with respect to a tread half width that begins at the tire equatorial plane and ends at the respective tread ground contacting area ends.

Next, functions of the pneumatic tire recited in claim 9 is described.

By providing, at the both sides of the tire equatorial plane of the tread, the circumferential grooves extending in the tire circumferential direction, the circumferential grooves are disposed in areas, within 40 to 60% from the tire equatorial plane side with respect to a tread half width that begins at the tire equatorial plane and ends at the respective tread ground contacting area end, water drainage is improved and wet road hydroplaning performance is further improved.

It should be noted that, if the circumferential grooves are disposed at the tire equatorial plane side with respect to the above area, rigidity around the tread center becomes insufficient, and this may result in lower steering stability.

On the other hand, if the circumferential grooves are disposed at tread ground contacting area end side with respect to the above area, rigidity of blocks at outer sides from the circumferential grooves is reduced, and this may result in lower steering stability and higher uneven wcar.

It should be noted that, in the pneumatic tire recited in claim 9, although the tread includes the circumferential grooves, lowering of the rain groove wandering resistance is practically ignorable, since the number of the circumferential grooves is small (two).

### EFFECTS OF THE INVENTION

As described above, the pneumatic tire recited in claim 1 having the above described structure has an excellent effect that rain groove wandering resistance performance can be improved without sacrificing wet performance and steering stability.

The pneumatic tire recited in claim 2 having the above described structure has excellent effects that the recessed portions can work to efficiently drain water from the kicking-in side into the steep-angle grooves, and therefore high wet performance can be obtained.

The pneumatic tire recited in claim 3 having the above described structure has an excellent effect that high steering stability can be obtained.

The pneumatic tire recited in claim 4 having the above described structure has an excellent effect that water in the vicinity of the tire equatorial plane in the ground contacting area can be efficiently drained, and therefore high wet performance can be obtained.

The pneumatic tire recited in claim 5 having the above described Structure has excellent effects that high wet performance can be obtained while ensuring rigidity of the land portions.

The pneumatic tire recited in claim 6 having the above described structure has excellent effects that pattern noise can be suppressed, and uniform land portion rigidity along the circumference and water drainage ability can be obtained.

The pneumatic tire recited in claim 7 having the above described structure has an excellent effect that high water drainage ability on a wet road can be obtained.

The pneumatic tire recited in claim 8 having the above described structure has an excellent effect that water led into the steep-angle grooves can be efficiently drained to the tire axial direction outer sides of the ground contacting area through the transverse grooves, and therefore, high wet performance can be obtained.

The pneumatic tire recited in claim 9 having the above described structure has an excellent effect that water drainage ability on a wet road can further be improved with avoiding rain groove wandering.

### BRIEF DESCRIPTION OF THE DRAWINGS

FIG. 1 is a plan view of a tread of a pneumatic tire according to one embodiment of the present invention;

FIG. 2A is a sectional view taken along line 2(A)-2(A) in FIG. 1, FIG. 2B is a sectional view taken along line 2(B)-2(B) in FIG. 1, and FIG. 2C is a sectional view taken along line 2(C)-2(C) in FIG. 1;

FIG. 3 is a plan view of a tread of a pneumatic tire according to prior art example 1;

FIG. 4 is a plan view of a tread of a pneumatic tire according to prior art example 2; and

FIG. 5 is a sectional view taken along line 5-5 in FIG. 4.

### BEST MODE FOR CARRYING OUT THE INVENTION

Hereinafter, an example of the embodiment of the present invention will be described in detail with reference to the drawings.

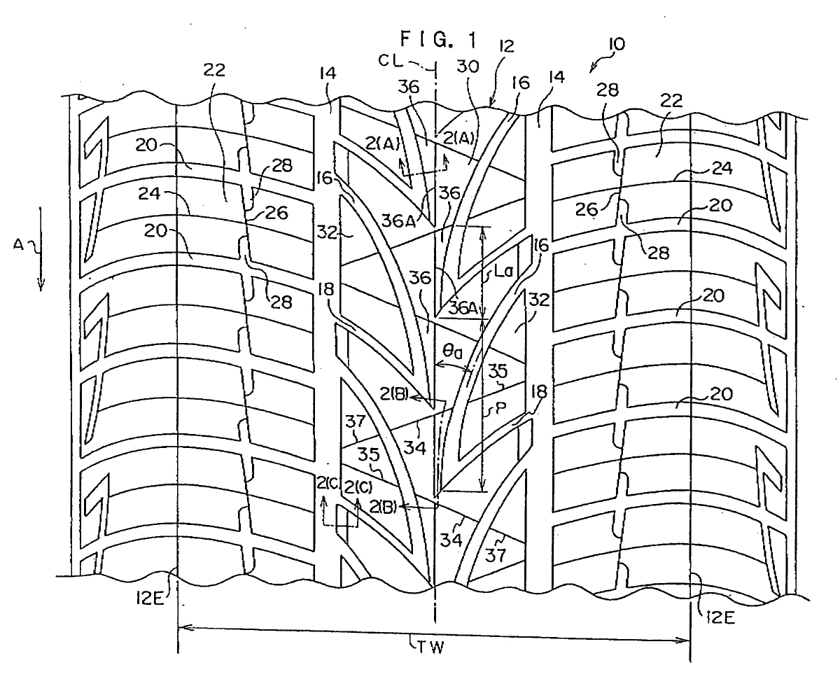

As shown in FIG. 1, a tread 12 of a pneumatic tire 10 includes circumferential grooves 14 formed at opposite sides of a tire equatorial plane CL, and each circumferential groove 14 extends in a straight line along the tire circumferential direction.

Each circumferential groove 14 is preferably provided in areas located, in a tire width direction, within 40 to 60% from the tire equatorial plane side with respect to a tread half width (½ TW) that begins at the tire equatorial plane CL and ends at the respective tread ground contacting area ends 12E

Here, the tread width TW refers to a dimension measured along tire width direction from the tread ground contacting area end 12E at one side in the tire width direction to the tread ground contacting area end 12E at another side in the tire width direction.

The tread ground contacting area end 12E refers to an outermost end of the tread ground contacting area in the tire width direction when a pneumatic tire is mounted on a standard rim defined in JATMA YEAR BOOK (2003 Edition, The Japan Automobile Tire Manufacturers Association standard ), is filled with air to have an inner pressure of 100% of a pneumatic pressure (the maximum pneumatic pressure) corresponding to the maximum load capacity (the load shown in a bold text in the table of correspondence between inner pressures and loads) in the applicable size/ply rating described in JATMA YEAR BOOK, and is loaded to the maximum load capacity.

It should be noted that, in cases where other standards such as the TRA standard and the ETRTO standard are applied according to places where the tire is used or manufactured, the rim, the pneumatic pressure and the load according to each standard are used.

Steep-angle grooves 16 are formed at intervals along the tire circumferential direction at the both sides of the tire equatorial plane CL. The steep-angle groove 16 is inclined with respect to the tire circumferential direction such that, when the pneumatic tire 10 rotates in the direction of arrow A, the steep-angle groove 16 contacts the ground from the side thereof at the tire equatorial plane CL side. End portion of the steep-angle grooves 16 at the tire equatorial plane CL side terminates within the land portion, and outer end thereof in the tire axial direction outer side opens in the circumferential groove 14.

The steep-angle grooves 16 at one side of the tire equatorial plane CL and the steep-angle transverse grooves 16 at the other side of the equatorial plane CL are arranged alternately.

It is preferred that an angle of the steep-angle groove 16 relative to the tire circumferential direction gradually decreases as from the tire axial direction outer sides toward the tire equatorial plane CL side.

The angle θa of the steep-angle grooves 16 relative to the tire circumferential direction is preferably not more than 45 degrees, and more preferably within a range from 5 to 30 degrees.

Further, gentle-angle grooves 18 are provided at the both sides of the tire equatorial plane CL. The gentle-angle grooves 18 each is provided between adjacent steep-angle grooves 16 in the tire circumferential direction. The gentle-angle grooves 18 incline in the same direction as the adjacent steep-angle grooves 16 in the tire circumferential direction, and an angle of the gentle-angle grooves 18 relative to the tire circumferential direction is larger than that of the steep-angle grooves 16.

Each end of the gentle-angle grooves 18 at the tire equatorial plane CL side connects to the respective ends of the steep-angle grooves 16 at the tire equatorial plane CL side and outer ends in the tire axial direction open in the circumferential grooves 14, respectively.

Transverse grooves 20 are provided at intervals in the tire circumferential direction at outer sides in the tire axial direction from the circumferential grooves 14. The transverse grooves 20 connect the circumferential grooves 14 to the tread ground contacting area ends 12E.

Shoulder blocks 22 are provided at outer sides in the tire axial direction with respect to the circumferential grooves 14. Each shoulder block 22 is defined by the circumferential groove 14 and the pair of transverse grooves 20.

Each shoulder block 22 includes a first side area sipe 24 that is in parallel with the transverse grooves 20, a second side area sipe 26 that extends in the circumferential direction, and short circumferential sub-grooves 28 formed at both ends of the second side area sipe 26.

Between the pair of circumferential grooves 14A, central land portion 30, which is continuous in the circumferential direction, is defined by the steep-angle grooves 16, the gentle-angle grooves 18 and the circumferential grooves 14. Further, substantially sector land portions 32 are defined by the steep-angle groove 16, the gentle-angle groove 18 and the circumferential groove 14.

In addition, first central area sipes 34, second central area sipes 35 and third central area sipes 37 are formed at intervals in the tire circumferential direction between the pairs of circumferential grooves 14. The first central area sipes 34, second central area sipes 35 and third central area sipes 37 are inclined with respect to the tire circumferential direction, and extend from one of the circumferential grooves 14 toward the other of the circumferential grooves 14.

It should be noted that the first central area sipes 34, the second central area sipes 35 and the third central area sipes 37 are arranged such that those sloping upwards from right to left and those sloping upwards from left to right, in a plan view of the tread, alternate in the tire circumferential direction.

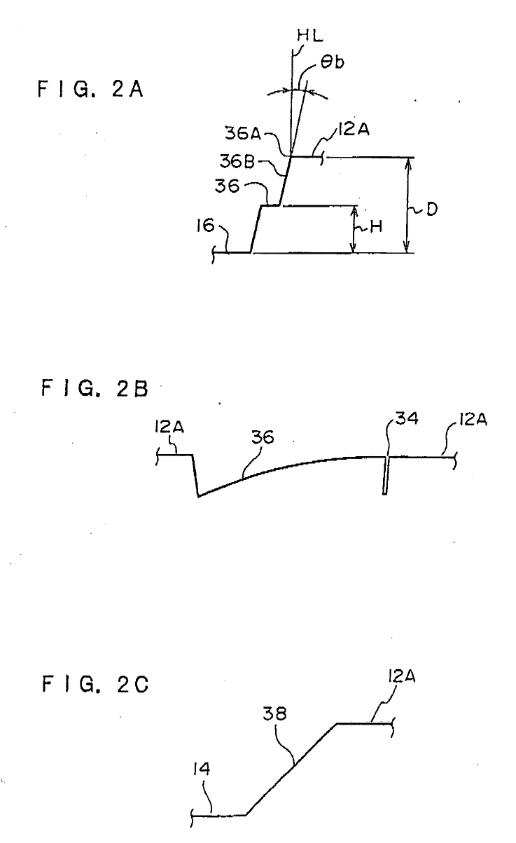

Recessed portion 36 is formed along a tread surface side edge of a land portion adjacent to an inner side in a tire axial direction of the steep-angle grooves 16 in the central land portion 30. The depth of the recessed portion 36 gradually increases (see FIG. 2(B)) and the width of the recessed portions 36 gradually decreases as from a middle portion in a longitudinal direction toward and end portion of the steep-angle groove 16 (in the present embodiment, from the first central area sipes 34) at the tire equatorial plane side.

Further, as shown in FIG. 2(A), when viewed in cross section along the tire radial direction that intersects the longitudinal direction of the steep-angle grooves, an angle θb of a land side wall surface 36B of each recessed portion 36 relative to a normal line HL with respect to a tread surface 12A of the tread 12 is preferably set to not more than 30 degrees.

As shown in FIG. 1, it is preferred that boundary lines 36A between the recessed portions 36 and the tread surface of the central land portion 30 at the tire equatorial plane CL side are arranged such that the boundary lines 36A of the recessed portions 36 at opposite sides of the tire equatorial plane CL are arranged on a straight line in the circumferential direction, or alternatively, they are spaced apart from each other at on outer side in the tire axial direction (not shown).

It should be noted that, although the boundary lines 36A extend as straight lines in the tire circumferential direction in the present embodiment, they may be inclined at an angle of not more than 15 degrees relative to the tire circumferential direction.

Further, a length La of the recessed portion 36 measured along the tire circumferential direction is preferably set within a range of from 25 to 50% of an arrangement pitch P of the steep-angle grooves 16 in the tire circumferential direction.

As shown in FIG. 2(A), a height H of the deepest portion of each recessed portion 36, which is measured from the groove bottom of the adjacent steep-angle groove 16 toward an outer side in a tire radial direction, is preferably set within a range from 25 to 75% of the groove depth D of the steep-angle groove 16.

It should be noted that, as shown in FIG. 2(C), a chamfered portion 38 is formed at each end portion of the central land portion 30 at the circumferential grooves 14 side. The chamfered portion 38 is inclined at a constant angle outward in the axial direction.

(Operation)

Next, operation of the pneumatic tire 10 of the present embodiment is described.

In the pneumatic tire 10 of the present embodiment, the steep-angle grooves 16 and the gentle-angle grooves 18 are disposed at the both sides of the tire equatorial plane CL. Further, the circumferential grooves 14 and the transverse grooves 20 are disposed at outer sides in the tire axial direction of the steep-angle grooves 16 and the gentle-angle grooves 18. This makes the tread pattern a so-called directional pattern, which can smoothly drain water in the ground contacting area, thereby providing basically high wet performance.

Further, the recessed portions 36 are formed along a tread surface side edge of a land portion 30 adjacent to an inner side in a tire axial direction of the steep-angle grooves 16. This allows smooth draining of water around the central area of the ground contacting area from the kicking-in side to the steep-angle transverse grooves 16 through the recessed portions 36.

Moreover, in the pneumatic tire 10 of the present embodiment, the number of the circumferential grooves 14 is small, and therefore, the rain groove wandering can be lessened on a road provided with rain grooves.

In addition, since the steep-angle grooves 16 are arranged with a mutual phase difference in the circumferential direction at respective sides of the tire equatorial plane CL, pattern noise can be suppressed, and land portion uniform rigidity along the circumference and water drainage ability can be obtained.

It should be noted that, since the depth of the recessed portions 36 gradually increases and the width of the recessed portions 36 gradually decreases from a middle portion in a longitudinal direction toward an end portion at the tire equatorial plane CL of the steep-angle grooves 16, rigidity of the central land portion 30 in the vicinity of the recessed portions 36 is ensured.

Further, by setting the angle of the boundary lines 36A relative to the tire circumferential direction in a plane view to not more than 15 degrees, and the angle θb of the land portion side wall surfaces 36B of the recessed portions 36 to not more than 30 degrees, the recessed portions 36 can work to efficiently drain water from the tire equatorial plane CL side to the steep-angle grooves 16.

It should be noted that, if the length La of the recessed portions 36 is less than 25% of the arrangement pitch P of the steep-angle grooves 16, the length of the recessed portion 36 is too short to efficiently drain water into the steep-angle grooves 16.

On the other hand, if the length La of the recessed portions 36 exceeds 50% of the arrangement pitch P of the steep-angle grooves 16, areas are produced where the recessed portions 36 provided at one side and the other side of the tire equatorial plane CL are positioned side by side in the axial direction, resulting in insufficient ground contacting area.

Moreover, if the height H of the deepest portions of the recessed portions 36 is less than 25% of the groove depth D of the steep-angle grooves 16, rigidity of the land portion in the vicinity of the recessed portions 36 excessively and unfavorably decreases.

On the other hand, if the height H of the deepest portions of the recessed portions 36 exceeds 75% of the groove depth D of the steep-angle grooves 16, efficient drainage of water into the steep-angle grooves 16 is hindered.

Furthermore, if the circumferential grooves 14 are arranged at the tire equatorial plane side with respect to the areas, within 40 to 60%. from the tire equatorial plane side with respect to a tread half width (½ TW) that begins at the tire equatorial plane and ends at the respective tread ground contacting area end, sufficient water-drainage is not achieved in the vicinity of the center of the tread.

On the other hand, if the circumferential grooves 14 are arranged outside with respect to the areas located, in a tire width direction, within 40 to 60% from the tire equatorial plane side with respect to a tread half width (½ TW) that begins at the tire equatorial plane and ends at the respective tread ground contacting area end, rigidity of the shoulder blocks 22 decreases, leading to lower steering stability and higher uneven wearing.

### EXAMPLES

In order to confirm the effects of the present invention, two types of pneumatic tires of prior art example and one type of a tire of an example to which the invention was applied were prepared. For each tire, wet road hydroplaning performance, dry road steering stability performance, and rain groove wandering resistance performance were tested.

Testing and Evaluation Methods for Wet Road Hydroplaning Performance:

Evaluation based on feel by a test driver at a maximum speed below a hydroplaning generation speed when a test vehicle was driving on a wet road with a water depth of 5 mm. The evaluation results are expressed by index numbers with those for the prior art example 1 being 100. The larger the value, the higher the performance.

Testing and Evaluation Methods for Dry Road Steering Stability Performance:

Evaluation based on feel by a test driver when a test vehicle was driving on a dry circuit course at various driving modes for sport driving. The evaluation results are expressed by index numbers with those for the prior art example 1 being 100. The larger the value, the higher the performance.

Testing Method for Rain Groove Wandering Resistance Performance:

Evaluation based on feel by a test driver for uncontrollability and instability in steering when a test vehicle was driving on a freeway in Los Angels, USA, at ordinary driving modes (straight-ahead driving, lane changing). The evaluation results are expressed by index numbers with those for the prior art example 1 being 100. The larger the value, the higher the performance.

### Tire of Example of the Invention

The pneumatic tire according to the above-described embodiment. Dimensions and angles of respective parts thereof are as shown in Table 1.

TABLE 1

| | | Angle θ of groove | |
|---|---|---|---|
| | | relative to | |
| | | circumferential | Groove |
| Name of parts | Width (mm) | direction (degrees) | depth (mm) |
| Circumferential | 10 | 0 | 9.2 |
| groove | | | |
| Steep-angle groove | 4-6 | 5-40 | 8 |
| Gentle-angle groove | 3 | 45-60 | 8 |
| Transverse groove | 5 | 75-90 | 8 |
| 1st central area sipe | 0.7 | 70 | 6 |
| 2nd central area sipe | 0.7 | 70 | 6 |
| 3rd central area sipe | 0.7 | 70 | 6 |
| 1st side area sipe | 0.7 | 75-90 | 6 |
| 2nd side area sipe | 0.7 | 10 | 6 |
| Circumferential | 5 | 10 | 4 |
| sub-groove | | | |

### Tire of Prior Art Example 1

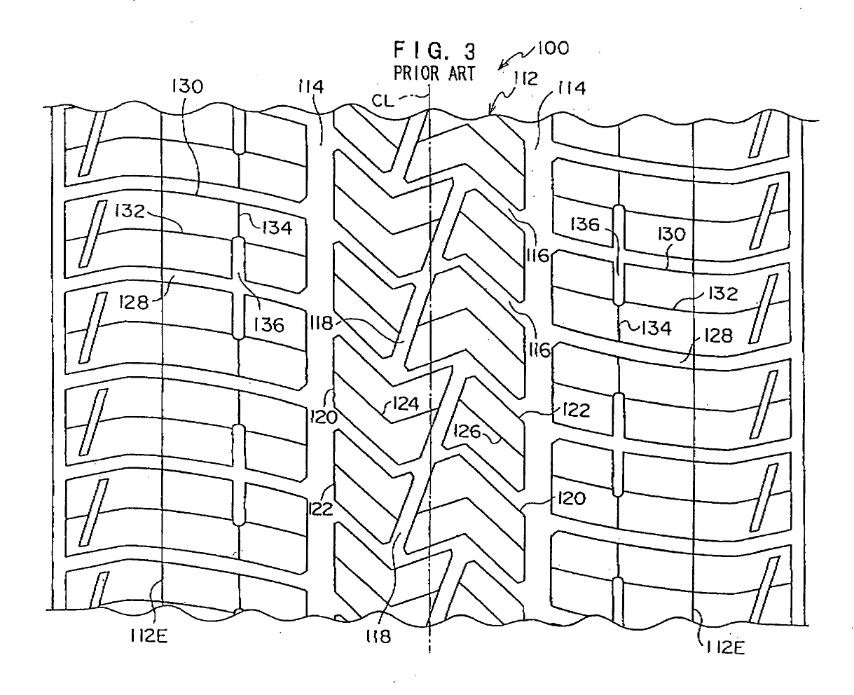

As shown in FIG. 3, a tread 112 of a pneumatic tire 100 includes circumferential grooves 114 extending in straight lines along the tire circumferential direction at the both sides of the tire equatorial plane CL.

The tread 112 includes, between the pair of circumferential grooves 114, larger central blocks 120 and smaller central blocks 122 which are defined by: first central-land transverse grooves 116 and second central-land transverse grooves 117 that extend to connect the pair of circumferential grooves 114; central-land steep-angle grooves 118 that are formed at the central portion and slope upwards from left to right, and the circumferential grooves 114.

Each smaller central block 122 includes a first central-land sipe 126, and each larger central block 120 includes a second central-land sipe 124.

Further, at the tire axial direction Outer sides of the circumferential grooves 114, shoulder blocks 130 are defined by side-land transverse grooves 128 and the circumferential grooves 114.

Each shoulder block 130 includes a first side-land sipe 132 that is in parallel with the side-land transverse grooves 128, a second side-land sipe 134 that extends in the circumferential direction, and a side-land circumferential sub-groove 136 that connects to one end of the second side-land sipe 134.

It should be noted that each reference numeral 112E designates a tread ground contacting area end.

Dimensions and angles of respective parts of the tire are as shown in Table 2 below.

TABLE 2

| | | Angle θ of groove | |
|---|---|---|---|
| | | relative to | |
| | | circumferential | Groove |
| Name of parts | Width (mm) | direction (degrees) | depth (mm) |
| Circumferential | 10 | 0 | 9.2 |
| groove | | | |
| Central-land | 6 | 20 | 8 |
| steep-angle groove | | | |
| 1st central-land | 5 | 50 | 8 |
| transverse groove | | | |
| 2nd central-land | 3.5 | 70 | 8 |
| transverse groove | | | |
| Side-land transverse | 5 | 75-85 | 8 |
| groove | | | |
| Side-land | 2.5 | 0 | 1 |
| circumferential | | | |
| sub-groove | | | |
| 1st central-land sipe | 0.7 | 50 | 6 |
| 2nd central-land sipe | 0.7 | 50, 70 | 6 |
| 1st side-land sipe | 0.7 | 75-85 | 6 |
| 2nd side-land sipe | 0.7 | 0 | 6 |

### Tire of Prior Art Example 2

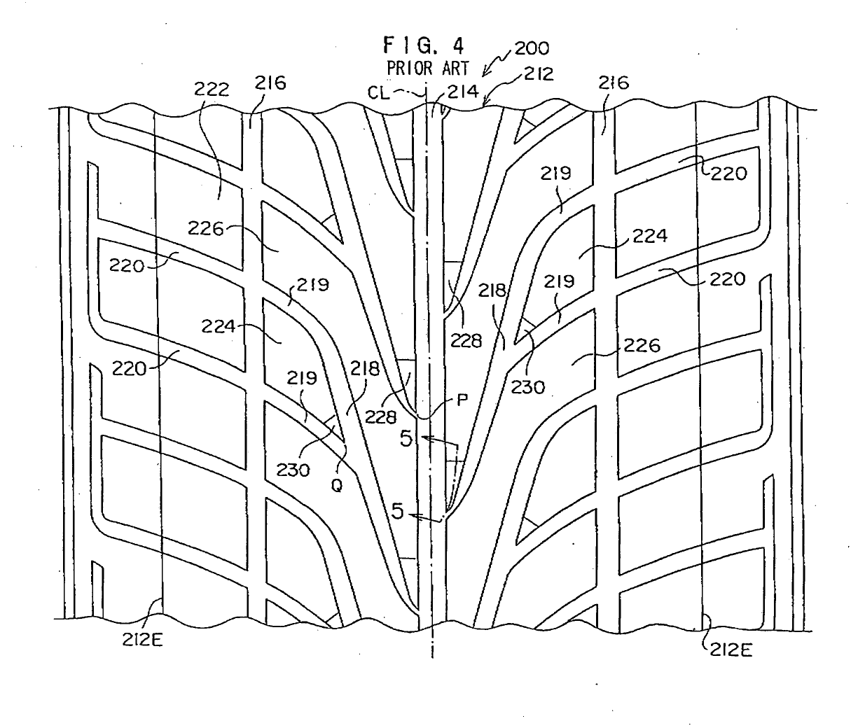

As shown in FIG. 4, a tread 212 of a pneumatic tire 200 includes blocks 222 near respective tread ground contacting area ends 212E, and blocks 224 and 226 at both sides of a central circumferential groove 214. The blocks 222, 224 and 226 are defined by: the central circumferential groove 214 that extends on the tire equatorial plane CL; a pair of side circumferential grooves 216 that extend along the central circumferential groove 214 and are arranged at opposite sides of the central circumferential groove 214; central-land steep-angle grooves 218 that are arranged at opposite sides of the tire equatorial plane CL and extend in an inclined direction with respect to the tire equatorial plane CL to join the central circumferential groove 214; central-land transverse grooves 219 that connect to the central-land steep-angle grooves 218; and side transverse grooves 220 that extend from the central circumferential groove 214 toward the respective tread ground contacting area ends 212E.

An angle of the central-land steep-angle grooves 218 relative to the tire circumferential direction is set small. Each central-land steep-angle groove 218 joins the central circumferential groove 214 at point P. Corner portions 228, which individually form an acute angle in the vicinity of the joining points, are defined by the central circumferential groove 214 and the central-land steep-angle grooves 218.

An angle of the central-land transverse grooves 219 relative to the tire circumferential direction is set larger than that of the central-land steep-angle grooves 218. Each central-land transverse groove 219 at one side joins the corresponding central-land steep-angle groove 218 at point Q, which is around the middle of an area between the center of the tread and one of the tread ground contacting area ends 212E. Corner portions 230 are defined in the vicinity of the joining point Q by the central-land steep-angle grooves 218 and the central-land transverse grooves 219.

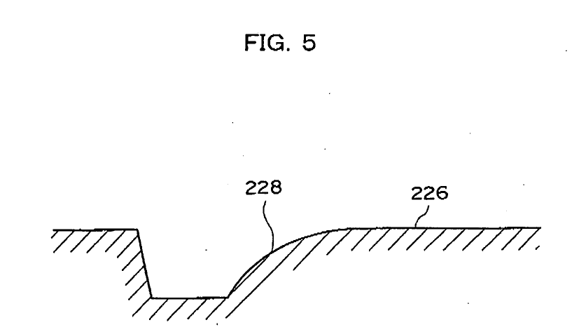

As shown in a sectional view of FIG. 5, each corner portion 228 is chamfered such that a convex portion is left at the tire radial direction outer side thereof. The corner portions 230 are also chamfered in the same manner as the corner portions 228.

Dimensions and angles of respective parts of the tire are as shown in Table 3.

TABLE 3

| | | Angle θ of groove | |
|---|---|---|---|
| | | relative to | |
| | | circumferential | Groove |
| Name of parts | Width (mm) | direction (degrees) | depth (mm) |
| Central | 10 | 0 | 9.2 |
| circumferential | | | |
| groove | | | |
| Side circumferential | 7 | 0 | 8 |
| groove | | | |
| Central-land | 7 | 15-60 | 8 |
| steep-angle groove | | | |
| Central-land | 5 | 55-60 | 8 |
| transverse groove | | | |
| Side transverse | 5 | 60-75 | 8 |
| groove | | | |

The Tire Size, the Inner Pressure and the Load were as Follows:

Tire size: PSR225/55R16 (with a tread width of 188 mm)

Inner pressure: 220 kPa

Load: equivalent to two persons in a real car

The results of the test are as shown in Table 4 below.

TABLE 4

| | Prior art | | Example of |
|---|---|---|---|
| | example 1 | Prior art example 2 | the invention |
| Wet road hydroplaning | 100 | 110 | 120 |
| performance | | | |
| (straight-ahead driving) | | | |
| Steering stability on Dry | 100 | 110 | 120 |
| road performance | | | |
| Rain groove wandering | 100 | 90 | 110 |
| resistance performance | | | |

As can be seen from the test results, the tire of the example to which the present invention is applied is superior in wet road hydroplaning performance, steering stability on dry road performance, and rain groove wandering resistance performance.

### INDUSTRIAL APPLICABILITY

This optimized tire pattern provides improved rain groove wandering resistance, allowing stable driving with good steering controllability on a road provided with rain grooves.

### DESCRIPTION OF THE REFERENCE NUMERALS

10: pneumatic tire
12: tread
12E: tread ground contacting area ends
14: circumferential grooves
16: steep-angle grooves
20: transverse grooves
22: shoulder blocks
30: central land portion
32: land portions
36: recessed portions
36A: boundary lines
36B: land side wall surface
HL: normal line
CL: tire equatorial plane

1.-9. (canceled)

10. A pneumatic tire comprising:
a land portion disposed on an equatorial plane of a tread, the land portion extending continuously in a tire circumferential direction;
steep-angle grooves provided at opposite sides of a tire equatorial plane of a tread, the steep-angle grooves being inclined at an angle of not more than 45 degrees relative to a tire circumferential direction such that the steep-angle grooves contact the ground from a side thereof near the tire equatorial plane, an end portion of each steep-angle groove near the tire equatorial plane terminating within the land portion; and
recessed portions formed in the land portion along adjacent tread surface side edges at a tire axial direction inner side of the steep-angle grooves, a depth of the recessed portions gradually increasing and a width of the recessed portions gradually decreasing from longitudinal directional middle portions of the steep-angle grooves toward end portions of the steep-angle grooves near the tire equatorial plane.

11. The pneumatic tire as claimed in claim 10, wherein
an angle, relative to the tire circumferential direction, of boundary lines between the recessed portions and a tread surface of the land portion near the tire equatorial plane is set to not more than 15 degrees when viewed in a plan view of the tread, and
an angle of land side wall surfaces of the recessed portions relative to lines normal to the tread surface of the tread is set to not more than 30 degrees when viewed in cross section along a tire radial direction that is orthogonal to the longitudinal direction of the steep-angle grooves.

12. The pneumatic tire as claimed in claim 10, wherein the boundary lines, near the tire equatorial plane, between the recessed portions and the tread surface of the land portion are arranged such that the boundary lines of the recessed portions at one side of the tire equatorial plane and the boundary lines of the recessed portions at another side of the tire equatorial plane are aligned in a straight line in the circumferential direction.

13. The pneumatic tire as claimed in claim 10, wherein the boundary lines, near the tire equatorial plane, between the recessed portions and the tread surface of the land portion are arranged such that the boundary lines of the recessed portions at one side of the tire equatorial plane and the boundary lines of the recessed portions at the other side of the tire equatorial plane are spaced apart from each other outward in the tire axial direction.

14. The pneumatic tire as claimed in claim 10, wherein the recessed portions are formed to extend from longitudinal directional middle portions of the steep-angle grooves to end portions of the steep-angle grooves near the tire equatorial plane, and a length of the recessed portions measured along the tire circumferential direction is set within a range from 25 to 50% of an arrangement pitch of the steep-angle grooves in the tire circumferential direction.

15. The pneumatic tire as claimed in claim 10, wherein a height of the deepest portion of each recessed portion measured from a groove bottom of the adjacent steep-angle groove to the tire radial direction outer side is set within a range from 25 to 75% of a groove depth of the steep-angle grooves.

16. The pneumatic tire as claimed in claim 10, wherein the steep-angle grooves are arranged with a phase difference in the circumferential direction between those at one side of the tire equatorial plane and those at the other side of the tire equatorial plane.

17. The pneumatic tire as claimed in claim 10, wherein an angle of the steep-angle grooves relative to the tire circumferential direction is set within a range from 5 to 30 degrees.

18. The pneumatic tire as claimed in claim 10, further comprising transverse grooves provided at the axial direction outer sides from the steep-angle grooves, the transverse grooves opening toward respective tread contact-area ends,
